(19) United States
(12) Patent Application Publication
(10) Pub. No.: US 2019/0291024 A1
(43) Pub. Date: Sep. 26, 2019

(54) FOAM CONTROL COMPOSITIONS COMPRISING SILICONE MATERIALS

(71) Applicant: Dow Silicones Corporation, Midland, MI (US)

(72) Inventors: BENBAKOURA Rahma, Seneffe (BE); CHAO Sung-Hsuen, Seneffe (BE); GUBBELS Frederic, Seneffe (BE); L'HOSTIS Jacqueline, Seneffe (BE)

(21) Appl. No.: 16/317,758

(22) PCT Filed: Aug. 3, 2017
(86) PCT No.: PCT/EP2017/069746

§ 371 Date: Jan. 14, 2019

(30) Foreign Application Priority Data
Aug. 3, 2016 (GB) 1613396.9
Mar. 6, 2017 (GB) 1701915.9

(51) Int. Cl. B01D 19/04; C08L 83/04; C08K 3/36; C08K 5/56; C08K 3/013

(52) U.S. Cl. CPC B01D 19/0409; C08L 83/04; C08K 3/36; C08K 5/56; C11D 3/0026; C08K 2201/005; C08K 2201/006; C08L 2312/08; C08K 3/013

(57) ABSTRACT

This disclosure relates to silicone-based foam control compositions for use in aqueous compositions which are liable to foam. The silicone-based foam control compositions comprise a silicone based material cured via a condensation cure chemistry. Also disclosed is a process to prepare the silicone-based foam control compositions and a process to control foam using said silicone-based foam control compositions.

This invention claims priority from patent application GB1613396.9 filed on Aug. 3, 2016 and from patent application GB1701915.9 filed on Mar. 6, 2017.

This disclosure relates to silicone-based foam control compositions for use in aqueous compositions which are liable to foam. The silicone-based foam control compositions comprise a silicone based material cured via a condensation cure chemistry. Also disclosed is a process to prepare the silicone-based foam control compositions and a process to control foam using said silicone-based foam control compositions.

In many aqueous systems which are used e.g. in food processes, paper making and pulping process, detergents, textile dyeing process, inks, coatings, paints, waste water treatment, sewage treatment and cleaning applications, scrubbing of natural gas, metal working process, the production of foam needs to be controlled or prevented. For example, it is important to keep the foam formation to an acceptable level when laundering is performed in automatic washing machines, especially front loading machines. Excessive foam would cause overflow of the washing liquor onto the floor as well as reduction in the efficiency of the laundering operation itself.

A variety of silicone materials exist in foam control systems. Silicone materials of various kind may be prepared using various reaction systems. Examples of silicone materials include at least straight-chain polymers, branched polymers, elastomeric polymers, gums, resinous structures. These silicone materials vary in their polymeric structure, in their viscosity or consistency, and in a lot of general properties such as hardness, flowability, stickiness, compatibility.

A variety of reaction mechanisms exist to produce the wide variety of silicone materials. Examples include hydrosilylation cure or addition cure, making use of vinyl-functional polymers, oligomers with Si—H groups, and a metal complex catalyst, such as platinum (Pt); peroxide cure or free radical cure utilizing free radicals generated by organic peroxides that decompose at elevated temperatures, initiating a crosslinking reaction; and

Silicone materials find uses in foam control application where they allow for the breaking of foam and preventing further formation of foam. In paper making and food processes, foam control allows for a better control of the process. In automatic front load machines, foam control prevents the overflow of foam out of the machine.

There is a continuous need to control foam from e.g. increased surfactant levels in the detergent compositions, use of surfactants which have a higher foam profile than traditional surfactants and changing laundering conditions. It is desirable to keep the addition level of foam control compositions to a minimum. There has therefore arisen a need to develop more efficient foam control compositions for incorporation into detergent compositions.

The present invention thus provides for silicone based materials cured via a condensation cure chemistry which may be used in foam control compositions to control the foam generated during the washing or processing of fibres, such as textile fibres or wood (e.g. pulp and paper) fibres.

The foam control compositions of the invention can be added to detergent compositions, particularly detergent powders, to inhibit excessive foaming when the detergent is used in washing. The foam control compositions may also be added in a pulp liquor to prevent excessive foaming during processing.

The present silicone-based foam control composition comprises
(a) a silicone based material cured via a condensation cure chemistry which is the condensation reaction product of:
   (i) at least one condensation curable silyl terminated polymer having at least one, typically at least 2 hydrolysable and/or hydroxyl functional groups per molecule;
   (ii) a cross-linker selected from silanes having at least 2 hydrolysable groups and/or silyl functional molecules having at least 2 silyl groups, each silyl group containing at least one hydrolysable group; and
   (iii) a condensation catalyst selected from the group of titanates or zirconates characterized in that the molar ratio of hydroxyl groups to hydrolysable groups is between 0.5:1 to 2:1 using a monosilane cross linker or 0.5:1 to 6:1 using disilyl crosslinker and the molar ratio of M-OR functions to the hydroxyl groups is comprised between 0.01:1 and 0.5:1, where M is titanium or zirconium; and
(b) a finely divided filler.

When free of filler, the condensation cured silicone material typically exhibits a hardness below Shore 80 in the type 00 scale according to ASTM D 2240-05(2010). Products having a hardness of Shore below 0 in the 00 scale, i.e. soft materials may also be obtained. The hardness of such materials are typically measured with the help of a penetrometer. The condensation cured materials can also be in a liquid (flowable) form, that is, in a form where the material can be poured from one container into another under the sole influence of gravity within minutes (in less than 60 minutes). In some instances the material may also be a thick paste that is not typically pourable, but “pumpable”, that is, it may be transferred from one recipient to the other by a pumping device. The material characterization may be carried out after reaction is fully complete, after several hours. In some instances, material characterization may be carried out after more than 7 days.

The main advantages of the present silicone based material cured via a condensation cure chemistry are to cure at room temperature, and to be more resistant to contaminants than platinum cure silicones.

The terms “silanol”, “hydroxysilyl”, “hydroxyl”, “SiOH” may be used interchangeably in the scope of the present invention, to indicate a condensation curable silyl terminating group of a polymer, bearing at least one hydroxyl functional group.

The terms “alkoxy”, “hydrolysable”, “SiOR” may be used interchangeably in the scope of the present invention, to indicate a condensation curable silyl terminating group of a polymer, bearing at least one hydrolysable functional group.

The terms “ratio SiOH/SiOR”, “ratio hydroxyl groups to hydrolysable groups”, “ratio silanol/alkoxy groups” may also be used interchangeably, in the scope of the present invention.

The relationship of molecular weight to viscosity of polydimethylsiloxane is described in scientific literature, for example, in at least Mills, E., European Polymer Journal, 1969, vol. 5, p. 675-695. The formula published in this article can be used to calculate approximately the weight average molecular weight of polymers (Mw) with an accuracy of about 10%. For condensation polymerization, the polydispersity index (PI) is the ratio Mw/Mn, and is approximately 2. From this relationship, the average molecular weight in number (Mn) can be calculated.

The Mn and Mw of silicone can also be determined by Gel Permeation Chromatography (GPC) with a precision of about 10-15%. This technique is a standard technique, and yields values for Mw (weight average), Mn (number average) and polydispersity index (PI) (where PI=Mw/Mn).

Mn value provided in this application have been determined by GPC and represent a typical value of the polymer used. If not provided by GPC, the Mn may also be obtained from calculation based on the dynamic viscosity of said polymer.

For example, the silanol content in mmol per 100 g of the Hydroxydimethylsilyl terminated polydimethyl siloxane can be determined with the average molecular weight in number (Mn) of the polymer using the following formula:

SiOH content (mmol/100 g of polymer)=2×100×1000/Mn

(where 100 is for amount in grams, 1000 is for mmol)

Similarly, the SiOR content in mmol per 100 g of the Trialkoxysilyl terminated polydimethylsiloxane of 56,000 mPa·s can be determined with the average molecular weight in number (Mn) of the polymer using the following formula:

SiOR content (mmol/100 g of polymer)=F×100×1000/Mn

where F represents the number of alkoxy function (SiOR) present in the polymer, ie 6 for hexa alkoxy functional polymers (and where 100 is for amount in grams, 1000 is for mmol).

For non-polymeric molecules the following formula can be used

SiOR content (mmol/100 g of polymer)=F×100×1000/MW

where F represents the number of alkoxy function present in the molecule and MW is the molecular weight of the molecule (and where 100 is for amount in grams, 1000 is for mmol).

The silanol molar content related to a polymer is equal to the amount in g of hydroxyl terminated polymer in 100 g of the mixed product divided by the average molecular weight in number of the polymer multiply by the average number of hydroxyl functions present in the polymer, typically 2. If there are several hydroxyl functional polymers in the formulation, the sum of the molar content of each polymer is summed up to constitute the total silanol molar content in the formulation. The total silanol molar content is calculated for 100 g of the mixed formulation.

The alkoxy molar content related to a substance is equal to the amount in g of alkoxy functional molecule in 100 g of the mixed product divided by the molecular weight of the molecule or the average molecular weight in number in case it is polymeric alkoxy functional molecule multiply by the average number of alkoxy functions present in the molecule. The sum of the molar content of each molecule or polymer is summed up to constitute the total alkoxy molar content in the formulation. The total alkoxy molar content is calculated for 100 g of the mixed formulation.

The silanol to alkoxy molar ratio is then calculated by dividing the total silanol molar content by the total alkoxy molar content.

Polymer (i) is at least one or alternatively a moisture/condensation curable silyl terminated polymer. Any suitable moisture/condensation curable silyl terminated polymer may be utilised including polydialkyl siloxanes, alkylphenyl siloxane, or organic based polymers with silyl terminal groups e.g. silyl polyethers, silyl acrylates and silyl terminated polyisobutylenes or copolymers of any of the above. Polymer (i) may be selected from polysiloxane based polymer containing at least two hydroxyl or hydrolysable groups and/or organic based polymer having silyl terminal groups, each bearing at least one hydrolysable group

The polymer (i) may be a polysiloxane based polymer containing at least two hydroxyl or hydrolysable groups, alternatively, the polymer comprises terminal hydroxyl or hydrolysable groups.

Examples of suitable hydroxyl or hydrolysable groups include —Si(OH)₃, —(R^{a})Si(OH)₂, —(R^{a})₂Si(OH), —R^{a}Si(OR^{b})₂, —Si(OR^{b})₃, —R^{a}₂SiOR^{b} or —(R^{a})₂Si—R^{c}—SiR^{d}ₖ(OR^{b})₃₋ₖ where each R^{a} independently represents a monovalent hydrocarbyl group, for example, an alkyl group, in particular having from 1 to 8 carbon atoms; each R^{b} and R^{d} group is independently an alkyl or alkoxy group in which the alkyl groups suitably have up to 6 carbon atoms; R^{c} is a divalent hydrocarbon group which may be interrupted by one or more siloxane spacers having up to six silicon atoms; and k has the value 0, 1 or 2.

Polymer (i) may have the general formula (1)

X³-A-X¹ (1)

where X³ and X¹ are independently selected from siloxane groups which terminate in hydroxyl or hydrolysable groups and A is a siloxane containing polymeric chain.

Examples of hydroxyl-terminating or hydrolysable groups X³ or X¹ include —Si(OH)₃, —(R^{a})Si(OH)₂, —(R^{a})₂Si(OH), —(R^{a})Si(OR^{b})₂, —Si(OR^{b})₃, —(R^{a})₂SiOR^{b} or —(R^{a})₂Si—R^{c}—Si(R^{d})ₚ(OR^{b})₃₋ₚ as defined above with each R^{b} group, when present, typically being a methyl group. The X³ and/or X¹ terminal groups may be hydroxydialkyl silyl groups, e.g. hydroxydimethyl silyl groups or alkoxydialkyl silyl groups e.g. methoxydimethyl silyl or ethoxydimethyl silyl.

Examples of suitable siloxane groups in polymeric chain A of formula (1) are those which comprise a polydiorgano-siloxane chain. Thus polymeric chain A may include siloxane units of formula (2)

—(R⁵ₛSiO₍₄₋ₛ₎₂)— (2)

in which each R⁵ is independently an organic group such as a hydrocarbyl group having from 1 to 10 carbon atoms optionally substituted with one or more halogen group such as chlorine or fluorine and s is 0, 1 or 2. Particular examples of groups R⁵ include methyl, ethyl, propyl, butyl, vinyl, cyclohexyl, phenyl, tolyl group, a propyl group substituted with chlorine or fluorine such as 3,3,3-trifluoropropyl, chlorophenyl, beta-(perfluorobutyl)ethyl or chlorocyclohexyl group. Suitably, at least some or substantially all of the groups R⁵ are methyl.

For the purpose of this application “substituted” means one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

Typically the polymers of the above type will have a viscosity in the order of 1,000 to 300,000 mPa·s, alternatively 1,000 to 100,000 mPa·s at 25° C. measured by using a Brookfield cone plate viscometer (RV DIII) using a cone plate.

Typical polymer (i) containing units of formula (2) are thus polydiorganosiloxanes having terminal, silicon-bound hydroxyl groups or terminal, silicon-bound organic radicals which can be hydrolysed using moisture as defined above. The polydiorganosiloxanes may be homopolymers or copolymers. Mixtures of different polydiorganosiloxanes having terminal condensable groups are also suitable.

The polymer (i) may alternatively be an organic based polymer having silyl terminal groups, each bearing at least one hydrolysable group. Typical silyl terminal groups include silyl polyethers, silyl acrylates and silyl terminated polyisobutylenes.

In the case of silyl polyethers, the polymer chain is based on polyoxyalkylene based units (organic). Such polyoxyalkylene units preferably comprise a linear predominantly oxyalkylene polymer comprised of recurring oxyalkylene units, (—CₙH₂ₙ—O—) illustrated by the average formula (—CₙH₂ₙ—O—)ₘ wherein n is an integer from 2 to 4 inclusive and m is an integer of at least four. The average molecular weight of each polyoxyalkylene polymer block may range from about 300 to about 10,000, but can be higher in molecular weight. Moreover, the oxyalkylene units are not necessarily identical throughout the polyoxyalkylene monomer, but can differ from unit to unit. A polyoxyalkylene block, for example, can be comprised of oxyethylene units, (—C₂H₄—O—); oxypropylene units (—C₃H₆—O—); or oxybutylene units, (—C₄H₈—O—); or mixtures thereof.

Other polyoxyalkylene units may include for example: units of the structure

-[—R^{e}—O—(—R^{f}—O—)ₚ-Pn-CR^{g}₂—Pn-O—(—R^{f}—O—)_{q}-R^{e}]—

in which Pn is a 1,4-phenylene group, each R^{e} is the same or different and is a divalent hydrocarbon group having 2 to 8 carbon atoms, each R^{f} is the same or different and is an ethylene group or propylene group, each R^{g} is the same or different and is a hydrogen atom or methyl group and each of the subscripts p and q is a positive integer in the range from 3 to 30.

The backbone of the organic section of polymer (i) which may contain organic leaving groups within the molecule, is not particularly limited and may be any of organic polymers having various backbones. The backbone may include at least one selected from a hydrogen atom, a carbon atom, a nitrogen atom, an oxygen atom, and a sulphur atom because the resulting composition has excellent curability.

Crosslinkers (ii) that can be used are generally moisture curing
silanes having at least 2 hydrolysable groups, alternatively at least 3 hydrolysable groups per molecule group; and/or
silyl functional molecules having at least 2 silyl groups, each silyl group containing at least one hydrolysable group.

Typically, a cross-linker requires a minimum of 2 hydrolysable groups per molecule and preferably 3 or more. In some instances, the crosslinker (ii) having two hydrolysable groups may be considered a chain extender. The crosslinker (ii) may thus have two but alternatively has three or four silicon-bonded condensable (preferably hydroxyl and/or hydrolysable) groups per molecule which are reactive with the condensable groups in organopolysiloxane polymer (i).

For the sake of the disclosure herein a monosilane cross-linker shall be understood to mean a molecule containing a single silyl functional group, which contains at least two hydrolysable groups.

For the sake of the disclosure herein a disilyl functional molecule is a silyl functional molecule containing two silyl groups, each silyl group containing at least one hydrolysable group. The disilyl functional molecule comprises two silicon atoms having each at least one hydrolysable group, where the silicon atoms are separated by an organic or siloxane spacer. Typically, the silyl groups on the disilyl functional molecule may be terminal groups. The spacer may be a polymeric chain.

For the sake of the disclosure herein a disilane is a silyl functional molecule having at least 2 silyl groups where the two silicon atoms are bonded to one another.

The hydrolysable groups on the silyl groups include acyloxy groups (for example, acetoxy, octanoyloxy, and benzoyloxy groups); ketoximino groups (for example dimethyl ketoximo, and isobutylketoximino); alkoxy groups (for example methoxy, ethoxy, and propoxy) and alkenyloxy groups (for example isopropenyloxy and 1-ethyl-2-methylvinyloxy). In some instances, the hydrolysable group may include hydroxyl groups.

The monosilane cross-linker (ii) include alkoxy functional silanes, oximosilanes, acetoxy silanes, acetonoxime silanes, enoxy silanes.

When the crosslinker is a silane and when the silane has three silicon-bonded hydrolysable groups per molecule, the fourth group is suitably a non-hydrolysable silicon-bonded organic group. These silicon-bonded organic groups are suitably hydrocarbyl groups which are optionally substituted by halogen such as fluorine and chlorine. Examples of such fourth groups include alkyl groups (for example methyl, ethyl, propyl, and butyl); cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. The fourth silicon-bonded organic groups may be methyl.

A typical monosilane may be described by formula (3)

R″₄₋ᵣSi(OR⁵)ᵣ (3)

wherein R⁵ is described above and r has a value of 2, 3 or 4. Typical silanes are those wherein R″ represents methyl, ethyl or vinyl or isobutyl. R″ is an organic radical selected from linear and branched alkyls, allyls, phenyl and substituted phenyls, acethoxy, oxime. In some instances, R⁵ represents methyl or ethyl and r is 3.

Another type of suitable crosslinkers (ii) are molecules of the type Si(OR⁵)₄ where R⁵ is as described above, alternatively propyl, ethyl or methyl. Partials condensates of Si(OR⁵)₄ may also be considered.

In one embodiment the cross-linker (ii) is a silyl functional molecule having at least 2 silyl groups having each at least 1 and up to 3 hydrolysable groups, alternatively each silyl group has at least 2 hydrolysable groups.

The crosslinker (ii) may be a disilyl functional polymer, that is, a polymer containing two silyl groups, each containing at least one hydrolysable group such as described by the formula (4)

Si(OR⁷)_{y}RvSi(OR⁷)_{z} (4)

where y and z are independently an integer of 1, 2 or 3, alternatively 2 or 3. Rv is an organic or polysiloxane-based fragment.

The disilyl functional crosslinker (ii) may have a siloxane or organic polymeric backbone. In the case of such siloxane or organic based cross-linkers the molecular structure can be straight chained, branched, cyclic or macromolecular. Suitable polymeric crosslinkers (ii) may have a similar polymeric backbone chemical structure to polymeric chain A as depicted in formula (1) above.

Examples of disilyl polymeric crosslinkers (ii) with a silicone or organic polymer chain bearing alkoxy functional end groups include 1,6-bis(trimethoxysilyl)hexane (alternatively known as hexamethoxydisilylhexane HMSH), polydimethylsiloxanes having at least one trialkoxy terminal where the alkoxy group may be a methoxy or ethoxy group.

Further examples of disilyl polymeric crosslinkers (ii) may be described by the general formula (5)

W—B—W

where W is —Si(R⁸)₂-(D)_{f}-R⁹—SiR⁸t(OR¹²)₃₋ₜ and
D is —R⁹—(Si(R⁸)₂—O)ₕ—Si(R⁸)₂—
R⁸ represents an alkyl group having from 1 to 6 carbon atoms, a vinyl group or a phenyl group, or fluorinated alkyl
R⁹ is a divalent hydrocarbon group
h is an integer between 1 and 6
f is 0 or an integer,
R¹² is an alkyl or alkoxy group in which the alkyl groups have up to 6 carbon atoms and
t has the value 0, 1 or 2
   and where B represents a linear backbone, which can be either organic or polysiloxane based.

A typical organic backbone B will be a polyether. A typical siloxane-based backbone B will be —[SiO_{(4-j)/2}(R¹)ⱼ]_{w}— where w is an integer from 50 to 5000; j is on average from 1.9 to 2; R₁ is selected from monovalent alkyl radical form 1 to 10 carbon atoms (alternatively 1 to 4 carbon atoms) or from monovalent halohydrocarbon radicals, cyanoalkyl radicals all with less than 18 carbon atoms.

In some instances, R⁸ is methyl, R⁹ is either a methylene or ethylene group, t is 0 or 1, R¹² is a methyl or ethyl group. In some instances, at least one W group is a —Si(R⁸)₂-(D)_{f}-R⁹—SiR⁸ₜ(OR¹²)₃₋ₜ group. A small proportion of W groups may be Si(alkyl)₃- groups (where the alkyl groups are preferably methyl groups).

Crosslinkers (ii) thus include alkyltrialkoxysilanes such as methyltrimethoxysilane (MTM) and methyltriethoxysilane, tetraethoxysilane, partially condensed tetraethoxysilane, alkenyltrialkoxy silanes such as vinyltrimethoxysilane and vinyltriethoxysilane, isobutyltrimethoxysilane (iBTM). Other suitable silanes include ethyltrimethoxysilane, vinyltriethoxysilane, phenyltrimethoxysilane, alkoxytrioximosilane, alkenyltrioximosilane, 3,3,3-trifluoropropyltrimethoxysilane, methyltriacetoxysilane, vinyltriacetoxysilane, ethyl triacetoxysilane, di-butoxy diacetoxysilane, phenyl-tripropionoxysilane, methyltris(methylethylketoximo)silane, vinyl-tris-methylethylketoximo)silane, methyltris(methylethylketoximino)silane, methyltris(isopropenoxy)silane, vinyltris(isopropenoxy)silane, ethylpolysilicate, n-propylorthosilicate, ethylorthosilicate, dimethyltetraacetoxydisiloxane, oximosilanes, acetoxy silanes, acetonoxime silanes, enoxy silanes and other such trifunctional alkoxysilanes as well as partial hydrolytic condensation products thereof; bis(trialkoxysilylalkyl)amines, bis(dialkoxyalkylsilylalkyl)amine, bis[trialkoxysilylalkyl) N-alkylamine, bis[dialkoxyalkylsilylalkyl) N-alkylamine, bis(trialkoxysilylalkyl)urea, bis(dialkoxyalkylsilylalkyl) urea, bis[3-trimethoxysilylpropyl)amine, bis[3-triethoxysilylpropyl)amine, bis[4-trimethoxysilylbutyl)amine, bis[4-triethoxysilylbutyl)amine, bis[3-trimethoxysilylpropyl) N-methylamine, bis[3-triethoxysilylpropyl) N-methylamine, bis[4-trimethoxysilylbutyl) N-methylamine, bis[4-triethoxysilylbutyl) N-methylamine, bis[3-trimethoxysilylpropyl)urea, bis[3-triethoxysilylpropyl)urea, bis[4-trimethoxysilylbutyl)urea, bis[4-triethoxysilylbutyl)urea, bis[3-dimethoxymethylsilylpropyl)amine, bis[3-diethoxymethylsilylpropyl)amine, bis[4-dimethoxymethylsilylbutyl)amine, bis[4-diethoxymethylsilylbutyl)amine, bis[3-dimethoxymethylsilylpropyl) N-methylamine, bis[3-diethoxymethylsilylpropyl) N-methylamine, bis[4-dimethoxymethylsilylbutyl) N-methylamine, bis[4-diethoxymethylsilylbutyl) N-methylamine, bis[3-dimethoxymethylsilylpropyl)urea, bis[3-diethoxymethylsilylpropyl)urea, bis[4-dimethoxymethylsilylbutyl)urea, bis[4-diethoxymethylsilylbutyl)urea, bis[3-dimethoxyethylsilylpropyl)amine, bis[3-diethoxyethylsilylpropyl)amine, bis[4-dimethoxyethylsilylbutyl)amine, bis[4-diethoxyethylsilylbutyl)amine, bis[3-dimethoxyethylsilylpropyl) N-methylamine, bis[3-diethoxyethylsilylpropyl) N-methylamine, bis[4-dimethoxyethylsilylbutyl) N-methylamine, bis[4-diethoxyethylsilylbutyl) N-methylamine, bis[3-dimethoxyethylsilylpropyl)urea bis[3-diethoxyethylsilylpropyl)urea, bis[4-dimethoxyethylsilylbutyl)urea and/or bis[4-diethoxyethylsilylbutyl)urea; bis(triethoxysilylpropyl)amine, bis(trimethoxysilylpropyl)amine, bis[trimethoxysilylpropyl)urea, bis[triethoxysilylpropyl)urea, bis(diethoxymethylsilylpropyl) N-methylamine; Di or Trialkoxy silyl terminated polydialkyl siloxane, di or trialkoxy silyl terminated polyarylalkyl siloxanes, di or trialkoxy silyl terminated polypropyleneoxide, polyurethane, polyacrylates; polyisobutylenes; Di or triacetoxy silyl terminated polydialkyl; polyarylalkyl siloxane; Di or trioximino silyl terminated polydialkyl; polyarylalkyl siloxane; Di or triacetonoxy terminated polydialkyl or polyarylalkyl. The cross-linker (ii) used may also comprise any combination of two or more of the above.

The molar ratio of hydroxyl groups to hydrolysable groups is between 0.5:1 to 2:1 using a monosilane cross-linker; or 0.5:1 to 6:1 using a disilyl functional cross-linker, alternatively 0.75:1 to 3:1, alternatively 0.75:1 to 1.5:1.

The composition further comprises a condensation catalyst. This increases the speed at which the composition cures. The catalyst chosen for inclusion in a particular silicone composition depends upon the speed of cure required.

Titanate and/or zirconate based catalysts may comprise a compound according to the general formula Ti[OR²²]₄ or Zr[OR²²]₄ where each R²² may be the same or different and represents a monovalent, primary, secondary or tertiary aliphatic hydrocarbon group which may be linear or branched containing from 1 to 10 carbon atoms. Optionally the titanate and/or zirconate may contain partially unsaturated groups. Examples of R²² include but are not restricted to methyl, ethyl, propyl, isopropyl, butyl, tertiary butyl and a branched secondary alkyl group such as 2, 4-dimethyl-3-pentyl. Alternatively, when each R²² is the same, R²² is an isopropyl, branched secondary alkyl group or a tertiary alkyl group, in particular, tertiary butyl. Suitable titanate examples include tetra n-butyl titanate, tetra t-butyl titanate, titanium tetrabutoxide, tetraisopropyl titanate, tetrakis(2-ethylhexyl) titanate. Suitable zirconate examples include tetra-n-propyl zirconate, tetra-n-butyl zirconate and zirconium diethylcitrate.

Alternatively, the titanate and/or zirconate may be chelated. The chelation may be with any suitable chelating agent such as an alkyl acetylacetonate (for example, methyl or ethylacetylacetonate). Alternatively, the titanate may be monoalkoxy titanates bearing three chelating agents such as for example 2-propanolato, tris isooctadecanoato titanate or diisopropyldiethylacetoacetate titanate. Further chelates include aminoalcohol ester chelates such as triethanolamine titanate chelate, diethanolamine titanate or di-isopropoxy-bis-(beta-diethanolamine ethoxy) titanate. Further chelates include organic acid or salt chelates such as the ammonium salt of a lactic acid titanate chelate.

The molar ratio of M-OR functions to the hydroxyl and/or hydrolysable groups in polymer (i) is comprised between 0.01:1 and 0.5:1, where M is titanium or zirconium. When a low amount of catalyst is used, it might be beneficial premix the catalyst with the crosslinker or with an optional diluent, thus allowing for a more reliable dosing. This process is typical for a person skilled in the art, and is sometimes referred to as “masterbatch”.

In some instances, the composition used to cure the material is a mixture of a condensation curable polymer (i), cross-linker (ii) and condensation catalyst (iii) as described above in combination with a hydrosilylation curable polymer together with a suitable cross-linker and hydrosilylation catalyst. Any suitable polymer curable via a hydrosilylation reaction pathway may be utilized. Such hydrosilylation curable polymers are known in the art. In some instances, the composition used to cure the material is a mixture of a condensation curable polymer (i), cross-linker (ii) and condensation catalyst (iii) as described above free of hydrosilylation curable polymer, hydrosilylation cross-linker and hydrosilylation catalyst.

The material as hereinbefore described is typically made from the condensation curable material composition which is stored in a 2 part manner, that is, in parts I and II. The two part compositions may be mixed using any appropriate standard two-part mixing equipment with a dynamic or static mixer.

Typically, the condensation curable composition is stored in two parts having polymer (i) and cross-linker (ii) in part I and polymer (i) and catalyst (iii) in part II. In some instances, the condensation curable composition is stored in two parts having cross-linker (ii) in part I and polymer (i) and catalyst (iii) in part II. In some further instances, the condensation curable composition is stored in two parts having a first polymer (i) and cross-linker (ii) in part I and a second polymer (ii) and catalyst (iii) in part II. The catalyst is typically held separate from polymer (i) and cross-linker (ii) until condensation reaction is desired to start. When additives are present, these may be present in any of parts I and II or in both parts.

The condensation curable material composition based on titanate/zirconate cure catalysts can be cured to a bulk cure in a few minutes to a few hours depending on the composition. Typically, the curing reaction takes place at temperatures ranging of from 15 to 80° C., alternatively 20 to 50° C., alternatively 20-25° C.

In neat form, the cured silicone based material may be in the form of a gel, a branched polymer, an elastomeric structured siloxane. Neat form in the scope if the present invention means the material is comprised of the reaction product of the reactant polymer (i), crosslinker (ii) and catalyst (iii). Viscosities and consistencies of the neat material may vary. Characterization methods includes the use of a texture analyser, to assess hardness or penetration. Materials typically having a penetration positive force at 5 mm of maximum 10 g are easier to handle and are easier to emulsify. However, antifoam property is shown even for materials having a penetration at 5 mm of more than 10 g, for example up to 25 g. The material characterization may be carried out after reaction is fully complete, after several hours. In some instances, material characterization may be carried out after more than 7 days.

The finely divided filler (b) to be used in the present foam control composition is a finely divided particulate material. It may be any of the known inorganic fillers suitable for formulating foam control compositions. Such fillers are described in many patent applications and are commercially available. They include fumed TiO2, Al₂O₃, aluminosilicates, zinc oxide, magnesium oxide, salts of aliphatic carboxylic acids, polyethylene wax, reaction products of isocyanates with certain materials, e.g. cyclohexylamine, alkyl amides, e.g. ethylene or methylene bis stearamide and silica with a surface area as measured by BET measurement of at least 50 m²/g. Mixtures of two or more of these can be used.

Typical fillers are silica fillers which can be made according to any of the standard manufacturing techniques for example thermal decomposition of a silicon halide, a decomposition and precipitation of a metal salt of silicic acid, e.g. sodium silicate and a gel formation method. The silica may be a precipitated silica or a gel formation silica. The average particle size of these fillers may range from 0.1 to 20 μm but preferably is from 0.5 to 2.0 μm.

The surface of the finely divided filler particles is hydrophobic in order to make the foam control composition sufficiently effective in aqueous systems. Where they are not naturally hydrophobic, the filler particles may be rendered hydrophobic, by techniques known in the art.

The hydrophobic treatment of the filler particles may be effected by treatment of said filler particles with treating agents, e.g. fatty acids, reactive silanes or siloxanes, for example stearic acid, dimethyldichlorosilane, trimethylchlorosilane, hexamethyldisilazane, hydroxy-endblocked and methyl-endblocked polydimethylsiloxanes and siloxane resins. Fillers which have already been treated with such compounds are commercially available from many companies, for example Sipernat® D10 from Degussa.

The surface of the filler may alternatively be rendered hydrophobic in situ, i.e. after the filler has been dispersed in the silicone based material (a) component. This may be effected by adding to the silicone based material prior to, during or after the dispersion of the filler, the appropriate amount of a treating agent, for example of the kind described above, and causing some reaction to take place, for example by heating the mixture to a temperature above 40° C. The quantity of treating agent to be employed will depend for example on the nature of the agent and the filler and will be evident or ascertainable by those skilled in the art. Sufficient treating agent should be employed to endow the filler with at least a discernible degree of hydrophobicity. Alternatively, the surface of the filler is rendered hydrophobic before dispersion in the reagent mixture.

The finely divided filler may thus be added before or after the condensation cure of the silicone based material. The handling is simplified when the finely divided filler is added before the condensation reaction occurs. That is, the filler may be added when polymer (i), (ii) and catalyst (iii) are brought in contact. The filler may be contained in any or both of parts I and part II.

The filler is added to the foam control agents in an amount of about 1 to 15%, alternatively 2 to 5% by weight.

The finely divided filler should however not bring a significant amount of moisture in the composition. The total moisture content brought about by the filler should not exceed 0.02% (which can be measured in accordance with ISO 787-2:1981) of the total composition. Suitable anhydrous filler may be utilised if required.

The foam control composition may contain an organosilicon resin which is associated with the silicone based material. Such an organosilicon resin can enhance the foam control efficiency of the silicone based material. In some instances, such organosilicon resin may be excluded from the present foam control composition.

The organosilicon resin is generally a non-linear siloxane resin and typically consists of siloxane units of the formula R′ₐSiO_{4-a/2} wherein R′ denotes a hydroxyl, hydrocarbon or hydrocarbonoxy group, and wherein a has an average value of from 0.5 to 2.4. It typically consists of monovalent trihydrocarbonsiloxy (M) groups of the formula R^{z}₃SiO_{1/2} and tetrafunctional (Q) groups SiO_{4/2} wherein R^{z} denotes a monovalent hydrocarbon group. The number ratio of M groups to Q groups is alternatively in the range 0.4:1 to 2.5:1 (equivalent to a value of a in the formula RₐSiO_{4-a/2} of 0.86 to 2.15), alternatively 0.4:1 to 1.1:1, alternatively 0.5:1 to 0.8:1 (equivalent to a=1.0 to a=1.33). The organosilicon resin is typically a solid at room temperature. The molecular weight of the resin can be increased by condensation, for example by heating in the presence of a base. The base can for example be an aqueous or alcoholic solution of potassium hydroxide or sodium hydroxide, e.g. a solution in methanol or propanol. A resin comprising M groups, trivalent RzSiO_{3/2} (T) units and Q units can alternatively be used, or up to 20% of units in the organosilicon resin can be divalent units R^{z}₂SiO_{2/2}. The group R^{z} is typically an alkyl group having 1 to 6 carbon atoms, for example methyl or ethyl, or can be phenyl. Typically, at least 80%, alternatively substantially all, R^{z} groups present are methyl groups. The resin may be a trimethyl-capped resin. Other hydrocarbon groups may also be present, e.g. alkenyl groups present for example as dimethylvinylsilyl units, alternatively not exceeding 5% of all R^{z} groups. Silicon bonded hydroxyl groups and/or alkoxy, e.g. methoxy, groups may also be present.

The organosilicon resin is typically present in the antifoam at 1-50% by weight based on the silicone based material cured via condensation cure reaction, alternatively 2-30%, alternatively 3-10%. The organosilicon resin may be soluble or insoluble in the silicone based material. If the resin is insoluble in the silicone based material, the average particle size of the resin may for example be from 0.5 to 400 μm, preferably 2 to 50 μm. The resin may be added before or after the condensation reaction of the silicone based material occurs. The resin may be present in any or both of parts I and II.

The foam control composition may also include a diluent. Such diluent may be useful to decrease the viscosity of the foam control composition sufficiently for application or emulsification.

Examples of diluents include silicon containing diluents such as hexamethyldisiloxane, octamethyltrisiloxane, and other short chain linear siloxanes such as octamethyltrisiloxane, decamethyltetrasiloxane, dodecamethylpentasiloxane, tetradecamethylhexasiloxane, hexadeamethylheptasiloxane, heptamethyl-3-{(trimethylsilyl)oxy)}trisiloxane, cyclic siloxanes such as hexamethylcyclotrisiloxane, octamethylcyclotetrasiloxane, decamethylcyclopentasiloxane, dodecamethylcyclohexasiloxane; further polydiorganosiloxane having a viscosity of from 500 to 12,500 mPa·s, measured at 25° C.; organic diluents such as butyl acetate, alkanes, alcohols, ketones, esters, ethers, glycols, glycol ethers, hydrocarbons, hydrofluorocarbons or any other material which can dilute the composition without adversely affecting any of the component materials. Hydrocarbons include isododecane, isohexadecane, Isopar L (C11-C 13), Isopar H (C11-C12), hydrogenated polydecene, mineral oil, especially hydrogenated mineral oil or white oil, liquid polyisobutene, isoparaffinic oil or petroleum jelly. Ethers and esters include isodecyl neopentanoate, neopentylglycol heptanoate, glycol distearate, dicaprylyl carbonate, diethylhexyl carbonate, propylene glycol n butyl ether, ethyl-3 ethoxypropionate, propylene glycol methyl ether acetate, tridecyl neopentanoate, propylene glycol methylether acetate (PGMEA), propylene glycol methylether (PGME), octyldodecyl neopentanoate, diisobutyl adipate, diisopropyl adipate, propylene glycol dicaprylate/dicaprate, and octyl palmitate. Additional organic diluents include fats, oils, fatty acids, and fatty alcohols.

The weight ratio of silicone material to diluent can for example be 100/0 to 10/90, alternatively 100/0 to 20/80. The diluent may be added before or after the condensation reaction of the silicone based material occurs, although it does not contribute to or participate in the condensation reaction. The diluent may be present in any or both of parts I and II.

The present invention provides a first process for making a foam control composition comprising a silicone material in which is dispersed a finely divided filler, which comprises the steps of
A) providing for a silicone based material cured via a condensation cure chemistry which is the condensation reaction product of:
   (i) at least one condensation curable silyl terminated polymer having at least one, typically at least 2 hydrolysable and/or hydroxyl functional groups per molecule;
   (ii) a cross-linker selected from silanes having at least 2 hydrolysable groups and/or polysilanes having at least 2 hydrolysable groups and/or polysilyl functional molecules having at least 2 silyl groups, each silyl group containing at least one hydrolysable group and
   (iii) a condensation catalyst selected from the group of titanates or zirconates characterized in that the molar ratio of hydroxyl groups to hydrolysable groups is between 0.5:1 to 2:1 using a monosilane cross linker or 0.5:1 to 6:1 using disilyl functional crosslinker and the molar ratio of M-OR functions to the hydroxyl groups is comprised between 0.01:1 and 0.5:1, where M is titanium or zirconium;
   (iv) in the presence of an optional diluent,
      subsequently
B) mixing the finely divided filler (b) in the silicone based material cured via a condensation cure chemistry.

The present invention provides a second process for making a foam control composition comprising a silicone material in which is dispersed a finely divided filler, which comprises the steps of
A) mixing prior to step (B) a finely divided filler (b) with
   (i) at least one condensation curable silyl terminated polymer having at least one, typically at least 2 hydrolysable and/or hydroxyl functional groups per molecule;
   (ii) a cross-linker selected from silanes having at least 2 hydrolysable groups and/or polysilanes having at least 2 hydrolysable groups and/or polysilyl functional molecules having at least 2 silyl groups, each silyl group containing at least one hydrolysable group and
   (iii) a condensation catalyst selected from the group of titanates or zirconates characterized in that the molar ratio of hydroxyl groups to hydrolysable groups is between 0.5:1 to 2:1 using a monosilane cross linker or 0.5:1 to 6:1 using disilyl functional crosslinker and the molar ratio of M-OR functions to the hydroxyl groups is comprised between 0.01:1 and 0.5:1, where M is titanium or zirconium;
   (iv) an optional diluent,
      subsequently
B) allowing the condensation reaction of components (i) and (ii) in the presence of the condensation catalyst (iii), optional diluent (iv) and finely divided filler (b).

The present invention provides for a third process for making a foam control composition comprising a silicone material in which is dispersed a finely divided filler, which comprises the steps of
A) providing for a silicone based material cured via a condensation cure chemistry which is the condensation reaction product of:
   (i) at least one condensation curable silyl terminated polymer having at least one, typically at least 2 hydrolysable and/or hydroxyl functional groups per molecule;
   (ii) a cross-linker selected from silanes having at least 2 hydrolysable groups and/or polysilanes having at least 2 hydrolysable groups and/or polysilyl functional molecules having at least 2 silyl groups, each silyl group containing at least one hydrolysable group and
   (iii) a condensation catalyst selected from the group of titanates or zirconates characterized in that the molar ratio of hydroxyl groups to hydrolysable groups is between 0.5:1 to 2:1 using a monosilane cross linker or 0.5:1 to 6:1 using disilyl functional crosslinker and the molar ratio of M-OR functions to the hydroxyl groups is comprised between 0.01:1 and 0.5:1, where M is titanium or zirconium;
   (iv) in the presence of an optional diluent,
      subsequently
B) mixing the finely divided filler in the silicone based material cured via a condensation cure chemistry;
   subsequently
C) emulsifying the mixture of step B).

The present invention provides for a fourth process for making a foam control composition comprising a silicone material in which is dispersed a finely divided filler, which comprises the steps of
A) mixing prior to step (B) a finely divided filler (b) with
   (i) at least one condensation curable silyl terminated polymer having at least one, typically at least 2 hydrolysable and/or hydroxyl functional groups per molecule;
   (ii) a cross-linker selected from silanes having at least 2 hydrolysable groups and/or polysilanes having at least 2 hydrolysable groups and/or polysilyl functional molecules having at least 2 silyl groups, each silyl group containing at least one hydrolysable group and
   (iii) a condensation catalyst selected from the group of titanates or zirconates characterized in that the molar ratio of hydroxyl groups to hydrolysable groups is between 0.5:1 to 2:1 using a monosilane cross linker or 0.5:1 to 6:1 using disilyl functional crosslinker and the molar ratio of M-OR functions to the hydroxyl groups is comprised between 0.01:1 and 0.5:1, where M is titanium or zirconium;
   (iv) an optional diluent; subsequently
A′) emulsifying the mixture of step A); subsequently
B) allowing the condensation reaction of components (i) and (ii) in the presence of the condensation catalyst (iii), optional diluent (iv) and finely divided filler (b).

Either of the 4 processes may be conducted at temperatures ranging of from 15 to 90° C., alternatively of from 20 to 60° C., alternatively of from 20 to 30° C., alternatively at room temperature (25° C.), using simple propeller mixers, counter-rotating mixers, or homogenizing mixers. No special equipment or processing conditions are typically required. Depending on the type of composition prepared, the method of preparation will be different, but such methods are well known in the art.

Emulsification includes the mixing of a dispersed phase with surfactants and continuous phase. Emulsification techniques are well known in the art. Suitable surfactants for the emulsification of foam control agents are well known and have been described in a number of publications. In typical emulsions, the continuous phase is usually water, but some alternative or additional materials may be used, which are compatible with water, such as alcohols or polyoalkylenes. The dispersed phase includes at least the silicone based material cured via a condensation cure chemistry, the finely divided filler and the optional diluent.

Suitable surfactants may comprise a nonionic surfactant, a cationic surfactant, an anionic surfactant, an amphoteric surfactant, or a mixture of such surfactants.

Examples of nonionic surfactants include sorbitan fatty esters, ethoxylated sorbitan fatty esters, glyceryl esters, fatty acid ethoxylates, alcohol ethoxylates R³—(OCH₂CH₂)ₐOH, particularly fatty alcohol ethoxylates and organosiloxane polyoxyethylene copolymers. Fatty alcohol ethoxylates typically contain the characteristic group —(OCH₂CH₂)ₐOH which is attached to a monovalent fatty hydrocarbon residue R³ which contains about eight to about twenty carbon atoms, such as lauryl (C12), cetyl (C16) and stearyl (C18). While the value of “a” may range from 1 to about 100, its value is typically in the range of about 2 to about 40, preferably 2 to 24. It is sometimes helpful to use a combination of surfactants to aid the emulsification.

More examples of nonionic surfactants include polyoxyethylene (4) lauryl ether, polyoxyethylene (5) lauryl ether, polyoxyethylene (23) lauryl ether, polyoxyethylene (2) cetyl ether, polyoxyethylene (10) cetyl ether, polyoxyethylene (20) cetyl ether, polyoxyethylene (2) stearyl ether, polyoxyethylene (10) stearyl ether, polyoxyethylene (20) stearyl ether, polyoxyethylene (21) stearyl ether, polyoxyethylene (100) stearyl ether, polyoxyethylene (2) oleyl ether, and polyoxyethylene (10) oleyl ether. These and other fatty alcohol ethoxylates are commercially available under trademarks and trade names such as ALFONICO, BRIJ, GENAPOL (S), NEODOL, SURFONIC, TERGITOL and TRYCOL. Ethoxylated alkylphenols can also be used, such as ethoxylated octylphenol, sold under the trademark TRITONS.

Examples of cationic surfactants include compounds containing quaternary ammonium hydrophilic moieties in the molecule which are positively charged, such as quaternary ammonium salts represented by R⁴₄N⁺Z⁻ where each R⁴ are independently alkyl groups containing 1-30 carbon atoms, or alkyl groups derived from tallow, coconut oil, or soy; and Z is halogen, i. e. chlorine or bromine. Suitable are dialkyldimethyl ammonium salts represented by R²₂N⁺ (CH₃)₂Z⁻, where each R² is an alkyl group containing 12-30 carbon atoms, or alkyl groups derived from tallow, coconut oil, or soy and X is as defined above. Monoalkyltrimethyl ammonium salts can also be employed, and are represented by R²N⁺(CH₃)₃X⁻ where R² and X are as defined above.

Some representative quaternary ammonium salts are dodecyltrimethyl ammonium bromide (DTAB), didodecyldimethyl ammonium bromide, dihexadecyldimethyl ammonium chloride, dihexadecyldimethyl ammonium bromide, dioctadecyldimethyl ammonium chloride, dieicosyldimethyl ammonium chloride, didocosyldimethyl ammonium chloride, dicoconutdimethyl ammonium chloride, ditallowdimethyl ammonium chloride, and ditallowdimethyl ammonium bromide. These and other quaternary ammonium salts are commercially available under trade names such as ADOGEN, ARQUAD, TOMAH and VARIQUAT.

Examples of anionic surfactants include sulfonic acids and their salt derivatives; alkali metal sulfosuccinates; sulfonate glyceryl esters of fatty acids such as sulfonate monoglycerides of coconut oil acids; salts of sulfonate monovalent alcohol esters such as sodium oleyl isothionate; amides of amino sulfonic acids such as the sodium salt of oleyl methyl tauride; sulfonate products of fatty acid nitriles such as palmitonitrile sulfonate; sulfonate aromatic hydrocarbons such as sodium alphanaphthalene monosulfonate; condensation products of naphthalene sulfonic acids with formaldehyde; sodium octahydro anthracene sulfonate; alkali metal alkyl sulfates such as sodium lauryl (dodecyl) sulfate (SDS); ether sulfates having alkyl groups of eight or more carbon atoms; and alkylaryl sulfonates having one or more alkyl groups of eight or more carbon atoms.

Some examples of commercial anionic surfactants include triethanolamine linear alkyl sulfonate sold under the tradename BIO-SOFT N-300 by the Stepan Company, Northfield, Ill.; sulfates sold under the tradename POLYSTEP by the Stepan Company; and sodium n-hexadecyl diphenyloxide disulfonate sold under the tradename DOWFAX 8390 by The Dow Chemical Company, Midland, Mich.

Examples of amphoteric surfactants include alkyl betaines, alkylamido betaines, and amine oxides, specific examples of which are known in the art.

Optional ingredients may also be included in the emulsions of foam control compositions according to the invention. These are well known in the art and include for example thickeners, preservatives, pH stabilisers etc. Suitable examples of thickeners include sodium alginate, gum arabic, polyoxyethylene, guar gum, hydroxypropyl guar gum, ethoxylated alcohols, such as laureth-4 or polyethylene glycol 400, cellulose derivatives exemplified by methylcellulose, methylhydroxypropylcellulose, hydroxypropylcellulose, polypropylhydroxyethylcellulose, starch, and starch derivatives exemplified by hydroxyethylamylose and starch amylose, locust bean gum, electrolytes exemplified by sodium chloride and ammonium chloride, and saccharides such as fructose and glucose, and derivatives of saccharides such as PEG-120 methyl glucose diolate or mixtures of 2 or more of these and acrylic polymer thickeners (e.g. those sold under the trade names PEMULEN and CARBOPOL). Suitable preservatives include the parabens, BHT, BHA and other well-known ingredients such as isothiazoline or mixtures of organic acids like benzoic acid and sorbic acid.

Where emulsification is performed, it may be useful to introduce another optional ingredient selected from a silicone resin having monofunctional (M) and tetrafunctional (Q) units and optionally difunctional (D) and/or trifunctional (T) units. The silicone resin may be for example an organosilicon compound with the average units of the general formula R³_{d}SiX_{4-d} in which R³ is a monovalent hydrocarbon group having 1 to 5 carbon atoms, X is a hydrolyzable group and d has an average value of one or less. Alternatively it may be a partially hydrolysed condensate of the organosilicon compound described immediately above. Examples are alkyl polysilicate wherein the alkyl group has one to five carbon atoms, such as methyl polysilicate, ethyl polysilicate and propyl polysilicate. The silicone resin may be the same or different from the silicone resin described previously in the frame of antifoam properties.

Typically it is a resin which only has M and Q units and is also known as MQ resin. The typical MQ resins are those consisting essentially of (CH₃)₃SiO_{1/2} units and SiO_{4/2} units wherein the ratio of (CH₃)₃SiO_{1/2} units to SiO_{4/2} units is from 0.4:1 to 1.2:1, alternatively a siloxane resin copolymer consisting essentially of (CH₃)₃SiO_{1/2} units and SiO₂ units in a molar ratio of approximately 0.75:1. These silicone resins have been known and described in a number of publications and are commercially available.

The present invention further provides for an emulsion comprising the present foam control composition, and at least one surfactant in water. That is, the combination of finely divided filler in the silicone based material cured via a condensation cure chemistry may be provided in an emulsion form, comprising at least one surfactant in a continuous water phase.

Typically emulsion comprises a continuous phase which is predominantly water and which is present in amounts from 30 to 95% by weight of the total weight of the emulsified foam control composition. The dispersed phase of said emulsion would normally provide from 5 to 50% by weight of the emulsion and the surfactants would represent from 1 to 20% by weight.

Alternative ways of providing the foam control compositions according to the invention include dispersions thereof. The present invention further provides for a dispersion comprising the present foam control composition, and at least one polar organic liquid. Examples of such dispersions include silicone/filler compositions comprising a continuous phase of a polar organic liquid having dispersed therein particles of silicone active material (such as a silicone antifoam). Examples of suitable polar organic liquids include propylene glycol, polyethylene glycols, polypropylene glycols and copolymers of polyethers, such as materials sold under the trade names of Pluriol® and Pluronic®. Polyorganosiloxane oxypolyalkylene copolymers may also be added to help render the dispersions self-emulsifiable in aqueous media. In some instances, the dispersion is a anhydrous dispersion.

Yet another suitable approach to deliver the foam control compositions according to the present invention is by providing them in particulate or granular form. Particulate foam control compositions often contain a carrier material for the foam control agent to make the foam control composition into a more substantial solid particulate material and facilitate its handling. The particulate foam control compositions are used for example by post-blending them as a powder with the rest of a powder detergent composition.

The present invention thus ultimately provides for a foam control granule comprising the present foam control composition and at least one carrier.

Materials that have been suggested as carrier materials for the foam control compositions in granular form include water soluble, water insoluble and water dispersible materials. Examples of carriers include sulphates such as sodium sulphate; carbonates such as anhydrous sodium carbonate or sodium carbonate monohydrate; soda ash; sodium perborate; phosphates, polyphosphates such as sodium tripolyphosphate; zeolite; silicas; silicates; clays; starches; cellulosic materials; cellulose derivatives such as sodium carboxymethylcellulose; aluminosilicates; sodium citrate; sodium acetate; sodium bicarbonate; sodium sesquicarbonate, and mixtures thereof.

The foam control composition comprising the silicone based material cured via a condensation cure chemistry and the finely divided filler, and optional additional ingredients as described above can thus be deposited on a carrier. Typically, the foam control composition is prepared by mixing all components, and optionally heating them to a temperature up to 90° C. (as necessary), to provide them in a liquid form. The mixture is thus deposited on the carrier particles at a temperature at which all components are liquid, for example a temperature in the range 25-100° C.

The foam control composition in granular form is typically made by an agglomeration process in which the foam control composition is sprayed onto the carrier particles while agitating the particles. The particles are typically agitated in a high shear mixer through which the particles pass continuously. In some instances, the foam control compositions are obtained by extrusion methods, which are well known in the art.

One type of suitable mixer is a vertical, continuous high shear mixer in which the foam control composition is sprayed onto the particles. One example of such a mixer is a Flexomix mixer supplied by Hosokawa Schugi. Alternative suitable mixers which may be used include horizontal high shear mixers, in which an annular layer of the powder-liquid mixture is formed in the mixing chamber, with a residence time of a few seconds up to about 2 minutes. Examples of this family of machines are pin mixers (e.g. TAG series supplied by LB, RM-type machines from Rubberg-Mischtechnik or pin mixers supplied by Lodige), and paddle mixers (e.g. CB series supplied by Lodige, Corimix (Trade Mark) from Drais-Manheim, Conax (Trade Mark) machines from Ruberg Mischtechnik). Other possible mixers which can be used are Glatt granulators, ploughshare mixers, as sold for example by Lodige GmbH, twin counter-rotating paddle mixers, known as Forberg (Trade Mark)-type mixers, intensive mixers including a high shear mixing arm within a rotating cylindrical vessel, such as “Typ R” machines sold by Eirich, Zig-Zag (Trade Mark) mixers from Patterson-Kelley, and HEC (Trade Mark) machines sold by Niro. Another possible granulation method is fluidized bed. Examples of fluid bed granulation machines are Glatt fluidized bed and Aeromatic/Niro fluidized bed units. In fluidized bed, agglomeration take place by atomizing the liquid dispersion (solution, suspension or emulsion) onto the suspended bed of particles to make the granules.

The granules generally have a mean particle diameter of at least 0.1 mm, alternatively over 0.25 or 0.5 mm, up to a mean diameter of 1.2 or 1.5 or even 2 mm.

The foam control composition in granular form may additionally include a water-soluble or water-dispersible binder to improve the stability of the particles. Examples of binders include polycarboxylates, for example polyacrylic acid or a partial sodium salt thereof or a copolymer of acrylic acid, for example a copolymer with maleic anhydride; polyoxyalkylene polymers such as polyethylene glycol, which can be applied molten or as an aqueous solution and spray dried; reaction products of tallow alcohol and ethylene oxide, or cellulose ethers, particularly water-soluble or water-swellable cellulose ethers such as sodium carboxymethylcellulose, or sugar syrup binders such as Polysorb 70/12/12 or LYCASIN 80/55 HDS maltitol syrup or Roclys C1967 S maltodextrin solution. The water-soluble or water-dispersible binder can be mixed with the foam control composition before being deposited on the carrier, but may also be deposited separately on the carrier particles.

Further binders include organic materials having a melting point in the range from 45 to 85° C. Such organic materials include water insoluble fatty acids, fatty alcohols and mixtures thereof or monoesters of glycerol and certain fatty acids. Examples include stearic acid, palmitic acid, myristic acid, arichidic acid, stearyl alcohol, palmityl alcohol, lauryl alcohol, monoesters of glycerol and aliphatic fatty acids having a carbon chain containing 12 to 20 carbon atoms, glyceryl monolaurate, glyceryl monomyristate, glyceryl monopalmitate and glyceryl monostearate.

The foam control composition in granular form may optionally contain a surfactant to aid dispersion of the foam control composition in the binder and/or to help in controlling the “foam profile”, that is in ensuring that some foam is visible throughout the wash without over foaming. Examples of such surfactants include silicone glycols, or fatty alcohol ether sulphate or linear alkylbenzene sulphonate, which may be preferred with a polyacrylic acid binder. The surfactant can be added to the foam control composition undiluted before the foam control composition is deposited on the carrier, or the surfactant can be added to the binder and deposited as an aqueous emulsion on the carrier. Such surfactant may be the same or different form the surfactant used for emulsification as described above.

The foam control composition in granular form may additionally contain ingredients such as a density adjuster, a colour preservative such as a maleate or fumarate, e.g. bis(2-methoxy-1-ethyl) maleate or diallyl maleate, a thickening agent such as carboxymethyl cellulose, polyvinyl alcohol or a hydrophilic or partially hydrophobed fumed silica, or a colouring agent such as a pigment or dye.

A granulated foam control composition according to the invention comprises a foam control composition comprising the silicone-based material cured via condensation cure chemistry and filler at 1-30% by weight of the total components, alternatively at 5-20% by weight; a binding agent at 1-30% by weight, alternatively 3-15% by weight; a surfactant at 0-20% by weight, alternatively 0-10% by weight; and solid particles at 40-90% by weight, alternatively 60-90% by weight.

The foam control compositions of the present invention can be used as any kind of foam control compositions, i.e. as defoaming agents and/or antifoaming agents. Defoaming agents are generally considered as foam reducers whereas antifoaming agents are generally considered as foam preventers. The foam control compositions of the present invention find utility in various media, typically aqueous media, such as inks, coatings, paints, detergents, including textile washing, laundry and auto dish washing, black liquor, and pulp and paper manufacture, waste water treatment, textile dyeing processes, the scrubbing of natural gas.

The foam control agents according to this invention are useful for reducing or preventing foam formation in aqueous systems, particularly foam generated by detergent compositions during laundering, and are particularly useful in liquid and powder detergent compositions which have a high foaming characteristic, for example those based on high levels of anionic surfactants, e.g. sodium dodecyl benzene sulphonate to ensure effectiveness of detergent composition at lower washing temperatures, e.g. 40° C.

In one embodiment, the present invention provides for the use of the foam control composition as described above to control foam in an aqueous environment selected from inks, coatings, paints, detergents, black liquor of from those encountered during pulp and paper manufacture, agrochemicals, construction chemicals, waste water treatment, textile dyeing processes or the scrubbing of natural gas.

In a further embodiment, the present invention provides for a process for controlling foam in an aqueous environment by providing for a foam control composition in an aqueous environment being selected from inks, coatings, paints, detergents, black liquor of from those encountered during pulp and paper manufacture, agrochemicals, construction chemicals, waste water treatment, textile dyeing processes or the scrubbing of natural gas.

In one embodiment, the present invention provides for a detergent composition comprising
1) a silicone-based foam control composition comprising
   (a) a silicone based material cured via a condensation cure chemistry
   (b) a finely divided filler; and
2) at least one detergent component.

The silicone based material cured via a condensation cure chemistry is as described above.

Suitable detergent components comprise an active detergent, organic and inorganic builder salts and other additives and diluents. The active detergent may comprise organic detergent surfactants of the anionic, cationic, non-ionic or amphoteric type, or mixtures thereof. Such detergent surfactant may be the same or different form the surfactant used for emulsification or granulation as described above.

Examples of anionic organic detergent surfactants include alkali metal soaps of higher fatty acids, alkyl aryl sulphonates, for example sodium dodecyl benzene sulphonate, long chain (fatty) alcohol sulphates, olefine sulphates and sulphonates, sulphated monoglycerides, sulphated ethers, sulphosuccinates, alkane sulphonates, phosphate esters, alkyl isothionates, sucrose esters and fluoro-surfactants.

Examples of cationic organic detergent surfactants include alkyl-amine salts, quaternary ammonium salts, sulphonium salts and phosphonium salts.

Examples of non-ionic organic surfactants include condensates of ethylene oxide with a long chain (fatty) alcohol or fatty acid, for example C14-15 alcohol, condensed with 7 moles of ethylene oxide (Dobanol 45-7), condensates of ethylene oxide with an amine or an amide, condensation products of ethylene and propylene oxides, fatty acid alkylol amides and fatty amine oxides.

Examples of amphoteric organic detergent surfactants include imidazoline compounds, alkylaminoacid salts and betaines.

Examples of inorganic components are phosphates and polyphosphates, silicates, such as sodium silicates, carbonates, sulphates, oxygen releasing compounds, such as sodium perborate and other bleaching agents and zeolites.

Examples of organic components are anti-redeposition agents such as carboxy methyl cellulose (CMC), brighteners, chelating agents, such as ethylene diamine tetra-acetic acid (EDTA) and nitrilotriacetic acid (NTA), enzymes and bacteriostatics.

Further materials suitable for the detergent component are well known to the person skilled in the art and are described in many text books, for example Synthetic Detergents, A. Davidsohn and B. M. Milwidsky, 6th edition, George Godwin (1978).

The foam control composition according to the invention may be added to the detergent component in a proportion of from 0.01 to 25% by weight based on the total detergent composition. Typically foam control agents are added in a proportion of from 0.1 to 5% by weight based on the total detergent composition. When in granular form, the foam control composition may be added to detergent powders at 0.1 to 10% by weight, preferably 0.2 to 0.5 or 1.0%.

It has been found that the foam control compositions of the present invention offer particular advantage when the foaming system comprises highly acid or highly basic aqueous environments, such as those having a pH of less than about 3 or greater than about 12. This holds particularly for highly acidic or basic systems at elevated temperatures. Thus, for example, under the extremely harsh conditions encountered in paper pulp manufacture, wherein the aqueous foaming medium (Kraft® process “black liquor”) has a pH of 12 to 14 and a temperature of 50° C. to 100° C., the foam control compositions of the present invention have been found to provide defoaming activity for considerably greater time periods than antifoam agents of the prior art. They also tend to provide a good antifoaming effect in that they knock down existing foam effectively.

In one embodiment, the present invention provides for a pulp/paper liquor comprising
1) a silicone-based foam control composition comprising
   (a) a silicone based material cured via a condensation cure chemistry
   (c) a finely divided filler; and
2) pulp/paper liquor.

Typically, the foam control composition in emulsion form is used in an amount of from 100 g to 1 kg of emulsion per ton of dry pulp produced. Typically, the foam control composition in emulsion form is used in an amount of from 5 to 500 μl of emulsion per 1 litre of black liquor.

### EXAMPLES

The following examples are included to demonstrate preferred embodiments of the invention. All percentages are in wt. %. All measurements were conducted at 23° C. unless indicated otherwise.

Penetration force using a Texture analyser is used to characterize the softness of the cured antifoam compounds, namely a TA XT plus texture analyser. The probe used is a polycarbonate cylinder terminated by a spherical end. The diameter of the probe and sphere is ½ inch. A return to start program was used. The pre-test speed is 5 mm/s and the trigger force is 0.1 g. The test speed is 1 mm/s. The probe is inserted to a distance of 5 mm in the product and then removed to a distance where no significant force is measured. The maximum positive and negative force is measured and reported here. A higher positive force is representative of a harder material. A higher negative force is representative of a more tacky material.

### Examples of Silicone Based Material Cured Via a Condensation Cure Chemistry

### Example 1

100 parts of SiOH terminated PDMS of 12,500 cSt is mixed using a High-speed Hauschild mixer with 240 parts of 200 fluid 1,000 cSt and 4 parts of hydrophobic silica (Sipernat D10 from Evonik). 30 parts of trimethoxysilyl terminated polydimethylsiloxane of 56,000 mPa·s (viscosity measured using a Brookfield cone plate viscometer RV DIII using a cone plate CP-52 at 5 rpm) having a Mn of 62,000 and a SiOR content of 9.67 mmol/100 g (=61001000/62000) is added and dispersed followed by 0.25 part Tetra-n-butyl titatane (Tyzor TnB). The resulting mixture is allowed to cure for 7 days at ambient temperature. Example 1 has a penetration force to 5 mm depth of 5 g; a ratio OH/OR of 1.63 and a ratio MOR/OH of 0.63.

### Example 2

100 parts of SiOH terminated PDMS of 12,500 cSt is mixed using a High-speed Hauschild mixer with 4 parts of hydrophobic silica (Sipernat D10 from Evonik). 0.2 parts Hexamethoxydisilyl-Hexane (HMSH is added and dispersed followed by 0.1 part Tetra-n-butyl titatane (Tyzor TnB). The resulting mixture is allowed to cure for 7 days at ambient temperature. Example 2 has a penetration force to 5 mm depth of 2 g; a ratio OH/OR of 1.26 and a ratio MOR/OH of 0.25.

### Example 3

100 parts of SiOH terminated PDMS of 12,500 cSt is mixed using a High-speed Hauschild mixer with 4 parts of hydrophobic silica (Sipernat D10 from Evonik). 10 parts of trimethoxysilyl terminated polydimethylsiloxane of 56,000 mPa·s as in Example 1 is added and dispersed followed by 0.25 part Tetra-n-butyl titatane (Tyzor TnB). The resulting mixture is allowed to cure for 1 day at ambient temperature. Example 3 has a penetration force to 5 mm depth of 3.3 g; a ratio OH/OR of 4.90 and a ratio MOR/OH of 0.28.

### Example 4

The same composition as Example 3 was prepared and allowed to cure for 7 days resulting to the material of Example 4 having a penetration force of 13 g.

### Example 5

100 parts of SiOH terminated PDMS of 12,500 cSt is mixed using a High-speed Hauschild mixer with 240 parts of 200 fluid 1,000 cSt and 4 parts of hydrophobic silica (Sipernat D10 from Evonik). 40 parts of trimethoxysilyl terminated polydimethylsiloxane of 56,000 mPa·s as in Example 1 is added and dispersed followed by 0.25 part Tetra-n-butyl titatane (Tyzor TnB). The resulting mixture is allowed to cure for 7 days at ambient temperature. Example 5 has a penetration force to 5 mm depth of 13.2 g; a ratio OH/OR of 1.22 and a ratio MOR/OH of 0.63.

### Example 6

100 parts of SiOH terminated PDMS of 12,500 cSt is mixed using a High-speed Hauschild mixer with 4 parts of hydrophobic silica (Sipernat D10 from Evonik). 0.3 parts Hexamethoxydisilyl-Hexane (HMSH) is added and dispersed followed by 0.2 part Tetra-n-butyl titatane (Tyzor TnB). The resulting mixture is allowed to cure for 7 days at ambient temperature.

Example 6 has a penetration force to 5 mm depth of 34 g; a ratio OH/OR of 0.84 and a ratio MOR/OH of 0.5.

### Example 7

Example 1 has been repeated with a half amount of Titanate catalyst: 100 parts of SiOH terminated PDMS of 12,500 cSt is mixed using a High-speed Hauschild mixer with 240 parts of 200 fluid 1,000 cSt and 4 parts of hydrophobic silica (Sipernat D10 from Evonik). 30 parts of trimethoxysilyl terminated polydimethylsiloxane of 56,000 mPa·s as in Example 1 is added and dispersed followed by 0.12 part Tetra-n-butyl titatane (Tyzor TnB). The resulting mixture is allowed to cure for 7 days at ambient temperature. Example 7 has a penetration force to 5 mm depth of 1.9 g.

### Comparative Example 1

Example 1 has been repeated but without Titanate catalyst providing for an unreacted material.

### Comparative Example 2: Branched PDMS Based Antifoam Compound Resulting from Alkaline Catalyzed SiOH Condensation Reaction

Such compound of Comparative example 2 is described in EP0217501. To a glass flask, equipped with thermometer, stirrer, dropping funnel and inert gas supply, were added 54.7 parts of trimethylsiloxy endblocked polydimethylsiloxane having a viscosity at 25° C. of 1,000 mPa s, 30.7 parts of a hydroxy-endblocked polydimethylsiloxane having on average molecular weight about 42,000, and 9.2 parts of a 25% solution in PDMS fluid of 1,000 mPa s of a polysiloxane resin having (CH₃)₃SiO_{1/2} units and SiO₂ units in a ratio of from 0.5:1 to 1.2:1. The mixture was stirred at room temperature till it was well mixed and then it was heated to 110° C. under nitrogen. When the mixture reached 80° C., 0.22 part of potassium isopropoxyde 10% in IPA was added and the temperature was held at 110 to 120° C. for 30 minutes. Then the mixture was allowed to cool down to 40° C. and 0.03 part of glacial acetic acid was added with 0.24 part water and stirred in to ensure complete neutralisation. The resulting liquid siloxane component had a viscosity of 20,000 mPa s at 25° C. 95 parts of this liquid siloxane component as prepared above were then mixed with 5 parts of hydrophobic silica Sipernat D10, supplied by Evonik, and a foam control composition (1) was obtained having a viscosity of 30,000 mPa s at 25° C. The compound of this comparative example 2 is also emulsified according the procedure described above.

Emulsions

Examples 1-7 and Comparative examples 1 and 2 have been incorporated into emulsion form: 6 part of antifoam compounds of each of Examples 1 to 7 and Comparative examples 1 and 2, is mixed with 1.12 part of a mixture of BRIJS2 (stearyl alcohol ethoxylate 2EO from Croda) and BRIJ S20 (stearyl alcohol ethoxylate 20EO from Croda) heated at 60° C. A thickener solution is added per portions of 4.0, 2.5 and 2.9 part, respectively. A final 13.5 part of water is added and mixing is applied to obtain an emulsion having particle size of 10-20 μm DV0.5.

The thickener solution is prepared by mixing 97.77 part demineralized water and 0.10 part Kathon LXE biocide (preparation of chloromethylisothiazolinone/methylisothiazolinone from Dow) and slowly adding 0.77 part Xanthan gum (Keltrol RD from CP Kelco) and 2.36 part Ethylhydroxycellulose (Natrosol 250LR from Ashland). Mixing at high shear is applied until the thickeners are well dispersed and dissolved. Viscosity is assessed at 0.5, 1 and 2.5 RPM using a Brookfield DIV-10040 spindle 4. Mixing is pursued until the viscosity reached around 120,000; 65,000; 30,000 cP respectively.

The ease of emulsification is summarized in the following Table 1. It was found that antifoam compositions such as Examples 4 to 6, having penetration force at 13 g and above are difficult to emulsify.

TABLE 1

| | Example 1 | Example 2 | Example 3 | Example 4 | Example 5 | Example 6 | Example 7 |
|---|---|---|---|---|---|---|---|
| Penetration force | 5 | 2 | 3.3 | 13 | 13.2 | 34 | 1.9 |
| to 5 mm depth (g) | | | | | | | |
| Emulsification after | OK/nice | OK/nice | OK/nice | Borderline/ | Difficult/ | Difficult/ | OK/nice |
| reaction | emulsion | emulsion | emulsion | Inhomogeous | Inhomogeous | Inhomogeous | emulsion |
| Emulsion particle | 16.7 | 10.5 | 19.2 | 32.8 | — | — | 18.9 |
| size (μm) - Dv0.5 | | | | | | | |
| Emulsion particle | 52.5 | 24.0 | 47.9 | 152.4 | — | — | 40.7 |
| size (μm) - Dv0.9 | | | | | | | |

Dispersions

A dispersion of Example 3 was provided according to WO2010091044, by combining the following ingredients:
30% silicone-based antifoam material of Example 3
2% crosslinked silicone polyether
2% MQ resin reacted with glycol
24% block copolymers based on ethylene oxide and propylene oxide having an average molecular weight of 3,000 to 5,000 and a HLB of 1 to 7, available as Pluronic® from BASF
43% Polypropylene glycol P2000 available as Sannix® PP-2000 or P-2000 from Sanyo Japan or Dow Chemicals.

The crosslinked silicone polyether is a cross-linked polydiorganosiloxane polymer having at least one polyoxyalkylene group prepared by adding 12.8 parts of a linear polysiloxane having the formula Me₃S_{I}O-(Me₂S_{I}O)io₈-(MeHS_{I}O)io-S_{I}Me₃, 2.6 parts of a polysiloxane having the formula VIMe₂SiO-(Me₂SiO)_{I}—SiMe₂Vi having a molecular weight of approximately 11,000 into a reactor, mixing, and heating to 80° C. Next, 0.001 parts of a 2% isopropanol solution of H₂PtCl₆.6H₂O were added and the mixture was reacted for 60 minutes, 60.2 parts of a polyoxyalkylene having the formula C₂H₄(EO)ᵤ(PO)ᵥOH where the ratio of u:v is 1:1 and having a molecular weight of approximately 3,100 and 24.4 parts of isopropanol were then added. The mixture was heated to 90° C. and 0.001 additional parts of a 2% isopropanol solution of H₂PtCl₆.6H₂O were added. The mixture was reacted at 90° C. for 2 hours, followed by a vacuum strip to remove the isopropanol. The mixture was cooled and filtered providing for said crosslinked silicone polyether.

The MQ resin reacted with glycol is a copolymer which is the reaction product derived by heating for 30 minutes at reflux a mixture of 100 g of a 50% (solids) xylene solution of a siloxane copolymer consisting essentially of SiO₄₇₂ units and (CHs)₃SiO_{1Z2} units in which the ratio of the SiCv₂ units to the (CHs)₃SiO_{1Z2} units is in the range of 1:0.4 to 1:1.2, 100 g of xylene, 200 g of a hydroxylated polyoxypropylene polymer having a molecular weight of about 4,100 (Voranol CP4100) in xylene, and 14 drops of a 1 N alcoholic KOH solution.

Foam Control Granules

Granule 1

3.4 parts of BRIJS2 (stearyl alcohol ethoxylate 2EO from Croda) and 3.4 parts of BRIJ S20 (stearyl alcohol ethoxylate 20EO from Croda) are heated at 60° C. and mixed together. 10.4 parts of Example 3 is added to the molten mix while stirring and increasing the temperature to 80° C. Then 6.8 parts of Lutensol AT80 (C16-C18 fatty alcohol ethoxylate from BASF) is added to the mixture. This molten mixture is then added to 76 parts of grinded sodium sulfate in a high shear mixer to obtain a granular material.

Granule 2

18.2 parts of a solution of PVA at 20% in water (Mowiol 4-88 from Curare) and 12.8 parts of Example 3 are mixed together. Then 5.5 parts of water is added to dilute this premix. This liquid preparation is added to 63.6 parts of zeolite 4A (from Ineos) in a high shear mixer to obtain a granular material. This granular material is then dried in a fluidized bed at 50° c. to remove the water.

Granule 3

6.7 parts of a solution of PVA at 20% in water (Mowiol 4-88 from Curare) and 26.9 parts of the emulsion of Example 3 described above are mixed together. This liquid preparation is added to 66.4 parts of zeolite 4A (from Ineos) in a high shear mixer to obtain a granular material. This granular material is then dried in a fluidized bed at 40° c. to remove the water.

Performance Results

Pump Test

The emulsified foam control composition above were tested in a foam cell using on softwood liquor. To this effect 600 ml of softwood is preheated at 90° C. and introduced in a graduated and thermostatically controlled glass cylinder having an inner diameter of 5 cm. This foamable liquid was circulated through a circulation pipe at a temperature adjusted to 89° C. The circulation flow rate is controlled using a MDR Johnson pump set up at a frequency of 50 Hz. When the foam height of 30 cm is reached, 150 μl of the tested foam control emulsion is injected in the liquid jet. The evolution of the foam height was monitored and recorded. The foam height was measured in cm over a sufficient period to allow the foam control composition to have exhausted its capacity, which is when the foam height of 29 cm has been reached again in the foam cell, and the time at which this occurred was measured as it indicates the longevity of the foam control composition. The time (in seconds) when first overflow occurred is provided.

The results were as shown in Table 2. Example 1, 2, 3 and 7 provided in emulsion form have better antifoam performance than a similar emulsion of Comparative example 2 which is obtained by SiOH condensation reaction. Comparative example 1 has no antifoam performance, indicating the unreacted raw materials have no specific foam control performance compared to the reacted materials.

TABLE 2

| | | | | | Emulsion of | Emulsion of |
|---|---|---|---|---|---|---|
| Time | Emulsion | Emulsion | Emulsion | Emulsion | Comparative | Comparative |
| (sec) | of Example 1 | of Example 2 | of Example 3 | of Example 7 | Example 1 | Example 2 |
| 0 | 30 | 30 | 30 | 30 | 30 | 30 |
| 20 | 13 | 19.5 | 17.5 | 13.5 | 16.5 | 18.5 |
| 40 | 15 | 17.5 | 17 | 15 | 23 | 20 |
| 60 | 16.5 | 20 | 19 | 16 | 27 | 22.5 |
| 80 | 18 | 22.5 | 19.5 | 18 | Overflow-70 | 25 |
| 100 | 18 | 23 | 21 | 18.5 | — | 27 |
| 120 | 18.5 | 24 | 23.5 | 18.5 | — | 24.5 |
| 140 | 20 | 24.5 | 26.5 | 20.5 | — | 26.5 |
| 160 | 21 | 28 | 28 | 21.5 | — | Overflow- |
| | | | | | | 150 |
| 180 | 23 | Overflow- | Overflow- | 22 | — | — |
| | | 160 | 160 | | | |
| 200 | 25.5 | — | — | 23.5 | — | — |
| 220 | 28 | — | — | 24.5 | — | — |
| 240 | Overflow- | — | — | 26 | — | — |
| | 220 | | | | | |
| 260 | — | — | — | Overflow- | — | — |
| | | | | 250 | | |

Washing Machine Test

The emulsions of Examples 3 and 7 and of Comparative example 1 were also tested in laundry application.

A model Heavy Liquid Detergent (HDL) system was used as laundry detergent. The model HDL detergent contained: 7% sodium lauryl ether sulfate (Marlinat 242/28 from Sasol), 7% dodecylbenzene sulfonate (Disponil LDBS 55 from Cognis), 7% fatty alcohol 7EO (Dehydol LT7 from BASF), 5% sodium tripolyphosphate, 5% glycerine and 69% water.

The antifoam performance was measured using the following protocol: 1.7 kg loads of towels were washed using the 60 g of the model HDL formulation together with 0.3 g of the antifoam emulsions examples described hereinabove. A Miele W1914 front loading washing machine was loaded with the towels and charged with 15 litres of soft water to which was added 14.5 ml of a 262 g/l CaCl₂.2H₂O aqueous solution and 25 ml of a 72 g/l MgCl₂.6H₂O aqueous solution.

The wash was performed using a 40° c. short cycle program with the spinning speed fixed at 1400 rpm. The foam height profile during the washing cycle was recorded every 5 minutes during the wash, through the glass window of the machine. Indications mean the height on the glass window, for example: 50=half window of foam, 100=full window of foam, 120=overflow from the washing machine. The results are set out in Table 3, indicating that the emulsions formulations of the present invention show excellent antifoam properties.

TABLE 3

| | | | Emulsion of |
|---|---|---|---|
| Time | Emulsion of | Emulsion of | Comparative |
| (min) | Example 7 | Example 3 | Example 1 |
| 0 | 0 | 0 | 0 |
| 5 | 0 | 7.5 | 2.5 |
| 10 | 2.5 | 7.5 | 37.5 |
| 15 | 7.5 | 10 | 47.5 |
| 20 | 12.5 | 10 | 97.5 |
| 25 | 17.5 | 15 | 100 |
| 30 | 35 | 20 | 100 |
| 35 | 45 | 25 | 100 |
| 40 | 52.5 | 32.5 | 100 |
| 45 | 60 | 40 | 100 |
| 50 | 65 | 47.5 | 100 |

1-14. (canceled)

15. A process for making a foam control composition comprising a silicone material in which is dispersed a finely divided filler, which comprises the steps of:
A) providing for a silicone based material cured via a condensation cure chemistry which is the condensation reaction product of:
(i) at least one condensation curable silyl terminated polymer having at least one hydrolysable and/or hydroxyl functional groups per molecule;
(ii) a cross-linker selected from silanes having at least 2 hydrolysable groups and/or polysilanes having at least 2 hydrolysable groups and/or polysilyl functional molecules having at least 2 silyl groups, each silyl group containing at least one hydrolysable group; and
(iii) a condensation catalyst selected from the group of titanates or zirconates characterized in that the molar ratio of hydroxyl groups to hydrolysable groups is between 0.5:1 to 2:1 using a monosilane cross linker or 0.5:1 to 6:1 using disilyl functional crosslinker and the molar ratio of M-OR functions to the hydroxyl groups is comprised between 0.01:1 and 0.5:1, where M is titanium or zirconium;
and subsequently:
B) mixing the finely divided filler (b) in the silicone based material cured via a condensation cure chemistry.

16. The process of claim 15 wherein the finely divided filler (b) is a silica with a surface area as measured by BET of at least 50 m2/g, selected from precipitated silica and gel formation silica with a particle size of from 0.5 to 2 μm.

17. A process for making a foam control composition comprising a silicone material in which is dispersed a finely divided filler, which comprises the steps of:
A) mixing prior to step (B) a finely divided filler (b) with
(i) at least one condensation curable silyl terminated polymer having at least one hydrolysable and/or hydroxyl functional groups per molecule;
(ii) a cross-linker selected from silanes having at least 2 hydrolysable groups and/or polysilanes having at least 2 hydrolysable groups and/or polysilyl functional molecules having at least 2 silyl groups, each silyl group containing at least one hydrolysable group; and
(iii) a condensation catalyst selected from the group of titanates or zirconates characterized in that the molar ratio of hydroxyl groups to hydrolysable groups is between 0.5:1 to 2:1 using a monosilane cross linker or 0.5:1 to 6:1 using disilyl functional crosslinker and the molar ratio of M-OR functions to the hydroxyl groups is comprised between 0.01:1 and 0.5:1, where M is titanium or zirconium;
and subsequently
B) allowing the condensation reaction of components (i) and (ii) in the presence of the condensation catalyst (iii) and finely divided filler (b).

18. The process of claim 17 wherein the finely divided filler (b) is a silica with a surface area as measured by BET of at least 50 m2/g, selected from precipitated silica and gel formation silica with a particle size of from 0.5 to 2 μm.

19. A process for making a foam control composition comprising a silicone material in which is dispersed a finely divided filler, which comprises the steps of:
A) providing for a silicone based material cured via a condensation cure chemistry which is the condensation reaction product of:
(i) at least one condensation curable silyl terminated polymer having at least one hydrolysable and/or hydroxyl functional groups per molecule;
(ii) a cross-linker selected from silanes having at least 2 hydrolysable groups and/or polysilanes having at least 2 hydrolysable groups and/or polysilyl functional molecules having at least 2 silyl groups, each silyl group containing at least one hydrolysable group; and
(iii) a condensation catalyst selected from the group of titanates or zirconates characterized in that the molar ratio of hydroxyl groups to hydrolysable groups is between 0.5:1 to 2:1 using a monosilane cross linker or 0.5:1 to 6:1 using disilyl functional crosslinker and the molar ratio of M-OR functions to the hydroxyl groups is comprised between 0.01:1 and 0.5:1, where M is titanium or zirconium;
and subsequently
B) mixing the finely divided filler in the silicone based material cured via a condensation cure chemistry;
and subsequently
C) emulsifying the mixture of step B).

20. The process of claim 19 wherein the finely divided filler (b) is a silica with a surface area as measured by BET of at least 50 m2/g, selected from precipitated silica and gel formation silica with a particle size of from 0.5 to 2 μm.
